(19) United States
(12) Patent Application Publication
(10) Pub. No.: US 2012/0006461 A1
(43) Pub. Date: Jan. 12, 2012

(54) METHOD OF MANUFACTURING PNEUMATIC TIRE AND PNEUMATIC TIRE

(75) Inventor: Masatoshi Oomiya, Osaka (JP)

(73) Assignee: TOYO TIRE & RUBBER CO., LTD., Osaka (JP)

(21) Appl. No.: 13/176,881

(22) Filed: Jul. 6, 2011

(30) Foreign Application Priority Data
Jul. 7, 2010 (JP) 2010-155044

(51) Int. Cl. B60C 9/18; B29D 30/08

(52) U.S. Cl. 152/526; 156/117

(57) ABSTRACT

A pneumatic tire is provided with a belt reinforcing layer obtained by spirally winding a reinforcing cord, in a tread side of a belt layer arranged in a tread portion. The method comprises a step of laminating a plurality of cylindrical belt plies including a belt cord extending while inclining with respect to a tire circumferential direction so as to form the belt layer, and a step of spirally winding the reinforcing cord on an outer periphery of the belt layer so as to form the belt reinforcing layer. A winding direction of the reinforcing cord is set to an inverse direction to a direction of inclination of the belt cord of the belt ply positioned in an outermost periphery.

### BACKGROUND OF THE INVENTION

1. Field of the Invention

The present invention relates to a method of manufacturing a pneumatic tire which is provided with a belt reinforcing layer obtained by spirally winding a reinforcing cord in a tread side of a belt layer arranged in a tread portion, and the pneumatic tire.

2. Description of the Related Art

Conventionally, for the purpose of an improvement of high speed durability (durability at a time of traveling at a high speed), there has been known a pneumatic tire in which a belt reinforcing layer is provided in a tread side of a belt layer arranged in a tread portion. As the belt reinforcing layer, a so-called spiral belt obtained by spirally winding a reinforcing cord along a tire circumferential direction is preferably used. In the spiral belt, such a joint position generated at a time of winding a wide ply is not generated, and it is advantageous in point of uniformity, a grip performance or the like.

This kind of belt reinforcing layer (that is, the spiral belt) can be formed by laminating cylindrical belt plies 5a and 5b on a forming drum 7 so as to form a belt layer 5, and thereafter spirally winding a reinforcing cord (a band-like body 8 including the reinforcing cord in the illustrated example) in an outer periphery thereof, as shown in FIG. 11. However, there is a case where the belt layer 5 lifts up from the forming drum 7 to thereby cause a displacement, at a time of forming the belt reinforcing layer 6, and it has been known that a uniformity of a tire, particularly a lateral force variation (LFV) which is associated with a force in a tire lateral direction is deteriorated due to it.

In Japanese Unexamined Patent Publication No. 2007-15577, there is described a pneumatic radial tire which is formed in such a manner that a tension of a reinforcing cord constructing a belt reinforcing layer gradually becomes smaller from an outer side of a vehicle installation toward an inner side of the vehicle installation, for the purpose of an improvement of a steering stability at a time of cornering. However, in the above structure, a tension of the reinforcing cord becomes relatively higher in the outer side of the vehicle installation, and it is thought that the belt layer lifts up in accordance therewith and there is a risk of tending to cause a displacement.

Further, in Japanese Unexamined Patent Publication No. 2003-220806, there is described a pneumatic tire which is formed by applying a comparatively lower tension to a leading end portion of a winding start portion of the belt reinforcing layer and a rear end portion of a winding end portion and applying a comparatively higher tension to an intermediate portion thereof, in order to make a step of rigidity in the leading end portion and the rear end portion smaller. However, even in the above structure, there is a case where the belt layer lifts up from a forming drum to thereby cause a displacement, and it cannot be said that an effect of preventing a deterioration of uniformity is sufficient.

### SUMMARY OF THE INVENTION

The present invention has been made in view of the above circumstances, and an object of the present invention is to provide a method of manufacturing a pneumatic tire which can prevent a deterioration of the LFV corresponding to a uniformity of the tire, while securing a high-speed durability obtained by the belt reinforcing layer, and the pneumatic tire.

The inventor of the present invention has made a study of the displacement caused by the lift of the belt layer, and has accordingly found that a reinforcing cord catches on an end portion of a belt cord 5C included in a belt ply 5b as shown in FIG. 1 (an arrow X is a winding direction of the reinforcing cord), at a time of forming the belt reinforcing layer as shown in FIG. 11, particularly at a time of covering the end portion of the belt layer while winding the reinforcing cord, and the belt layer 5 is pressed in such a manner so as to be approached to an inner side to thereby lift up from the forming drum. The present invention has been made based on the knowledge mentioned above, and can achieve the above object based on the structure as mentioned below.

That is, the present invention provides a method of manufacturing a pneumatic tire which is provided with a belt reinforcing layer obtained by spirally winding a reinforcing cord, in a tread side of a belt layer arranged in a tread portion, the method comprising:

a step of laminating a plurality of cylindrical belt plies including a belt cord extending while inclining with respect to a tire circumferential direction so as to form the belt layer; and

a step of spirally winding the reinforcing cord on an outer periphery of the belt layer so as to form the belt reinforcing layer,

wherein a winding direction of the reinforcing cord is set to an inverse direction to a direction of inclination of the belt cord of the belt ply positioned in an outermost periphery.

In this method, the reinforcing cord can be wound in a direction as shown in FIG. 2, with respect to the end portion of the belt cord of the belt play, by setting the winding direction of the reinforcing cord to an inverse direction to a direction of inclination of the belt cord of the belt ply positioned in an outermost periphery (an arrow Y is a winding direction of the reinforcing cord). Accordingly, the reinforcing cord becomes hard to catch on the end portion of the belt cord, or it becomes easy to set up against a pressure from the reinforcing cord even if it catches thereon, whereby it is possible to inhibit the belt layer from being moved close to the inner side. As a result, it is possible to suppress a generation of the displacement caused by the lift of the belt layer, while securing the high-speed durability generated by the belt reinforcing layer, and it is possible to prevent the deterioration of LFV corresponding to the uniformity of the tire.

In the above method, it is preferable that the step of forming the belt reinforcing layer is structured such as to spirally wind a band-like body including a plurality of the reinforcing cords arranged in a line from one end of the belt layer toward the other end via a center region, and makes a cord tension and a winding pitch of the band-like body smaller in a start end portion covering the one end of the belt layer, than in an intermediate portion covering the center region of the belt layer.

In accordance with the above method, it is possible to weaken the pressure of the reinforcing cord with respect to the end portion of the belt cord arranged in one end thereof, by making the cord tension of the band-like body smaller in the start end portion covering one end of the belt layer, whereby it is possible to effectively prevent the displacement caused by the lift of the belt layer. Further, it is possible to compensate for a reduction of a binding force caused by making the cord tension smaller, by making a winding pitch of the band-like body smaller in the start end portion, whereby it is possible to well secure the high-speed durability generated by the belt reinforcing layer.

In the above method, it is preferable that the step of forming the belt reinforcing layer makes the cord tension and the winding pitch of the band-like body smaller in a terminal end portion covering the other end of the belt layer, than in the intermediate portion covering the center region of the belt layer. In this case, it is possible to effectively prevent the deterioration of the LFV by setting the terminal end portion of the belt reinforcing layer to the same structure as the start end portion.

In the above method, it is preferable that the step of forming the belt reinforcing layer alternately arranges an arrangement portion in which the band-like body is arranged, and a defect portion in which the band-like body is not arranged, in the intermediate portion covering the center region of the belt layer. In this case, since the belt layer is not covered with the belt reinforcing layer, in a defect portion in the intermediate portion of the belt reinforcing layer, it is possible to enhance a degree of influence that a cord component of the belt ply positioned in the outermost periphery applies to a steering wheel flow.

In the above method, it is preferable that the adjacent band-like bodies overlap with each other in the arrangement portion. In accordance with the method mentioned above, it is possible to enhance a binding force with respect to the belt layer, in the intermediate portion of the belt reinforcing layer.

Further, the present invention provides a pneumatic tire which is provided with a belt reinforcing layer obtained by spirally winding a reinforcing cord, in a tread side of a belt layer arranged in a tread portion, wherein the belt layer is formed by laminating a plurality of cylindrical belt plies including a belt cord extending while inclining with respect to a tire circumferential direction, and the belt reinforcing layer sets a winding direction of the reinforcing cord to an inverse direction to a direction of inclination of the belt cord of the belt ply positioned in an outermost periphery.

In this pneumatic tire, it is possible to suppress a generation of the displacement caused by the lift of the belt layer, while securing the high-speed durability generated by the belt reinforcing layer, and it is possible to prevent the deterioration of LFV corresponding to the uniformity of the tire by setting the winding direction of the reinforcing cord to an inverse direction to a direction of inclination of the belt cord of the belt ply positioned in an outermost periphery.

### BRIEF DESCRIPTION OF THE DRAWINGS

FIG. 1 is an enlarged view showing an end portion of a reinforcing cord at a time of forming a belt reinforcing layer in FIG. 11;

FIG. 2 is an enlarged view showing an end portion of a reinforcing cord at a time of forming a belt reinforcing layer in FIG. 5;

FIG. 3 is a half cross sectional view of a tire meridian showing an example of a pneumatic tire in accordance with the present invention;

FIG. 4 is a plan view showing a belt layer and the belt reinforcing layer;

FIGS. 5(a) and 5(b) are plan views showing a state in which the belt reinforcing layer is formed according to the present invention;

FIG. 6 is a diagrammatic view showing the belt layer and the belt reinforcing layer;

FIG. 7 is a diagrammatic view showing a modified example of the belt reinforcing layer;

FIG. 8 is a diagrammatic view showing a modified example of the belt reinforcing layer;

FIG. 9 is a diagrammatic view showing a modified example of the belt reinforcing layer;

FIG. 10 is a diagrammatic view showing a modified example of the belt reinforcing layer;

FIGS. 11(a) and 11(b) are plan views showing a state in which the belt reinforcing layer is formed by a conventional method.

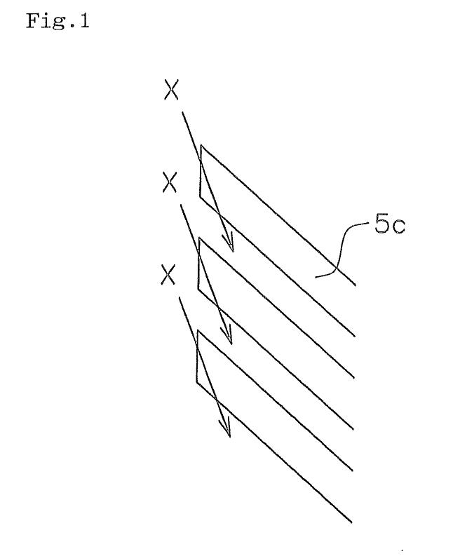

### DETAILED DESCRIPTION OF THE PREFERRED EMBODIMENTS

An embodiment of the present invention will be explained with reference to the drawings. First of all, a description will be briefly given of a structure of a pneumatic tire, and a description will be next given of a method of manufacturing the pneumatic tire. Since the method of manufacturing the pneumatic tire in accordance with the present invention can be carried out in the same manner as the conventional tire manufacturing step except a step of forming the belt reinforcing layer, a description will be given mainly of a step of forming a belt reinforcing layer. Further, the pneumatic tire in accordance with the present invention can be structured in the same manner as a normal pneumatic tire, except an employment of the belt reinforcing layer as mentioned below.

A tire T shown in FIG. 3 is a pneumatic radial tire which is provided with a pair of bead portions 1, side wall portions 2 extending to an outer side in a tire diametrical direction from the bead portions 1, a tread portion 3 connecting to respective outer ends in the tire diametrical direction of the side wall portions 2, and a toroidal carcass layer 4 provided between a pair of bead portions 1. The carcass layer 4 is constructed by at least one (two in the present embodiment) ply including a cord extending at an angle of approximately 90 degrees with respect to a tire equator CL, and both end portions thereof are folded back at the bead portion 1.

In the tread portion 3, a belt layer 5 is arranged in an outer periphery of the carcass layer 4, and a reinforcement based on a hoop effect is carried out. The belt layer 5 is formed by laminating a plurality of cylindrical belt plies 5a and 5b (laminating two layers in the present embodiment). As shown in FIG. 4, each of the belt plies 5a and 5b includes a belt cord 5C which extends while inclining with respect to a tire circumferential direction, and an angle θ of inclination is exemplified by approximately 25 degrees, more specifically 23 to 29 degrees. The belt cord 5C is constructed, for example, by a steel cord, and is arranged in such a manner so as to intersect inversely to each other between the plies.

The pneumatic tire T is provided with a belt reinforcing layer 6 obtained by spirally winding a reinforcing cord 60 along the tire circumferential direction to a tread side of the belt layer 5 which is arranged in the tread portion 3. The belt reinforcing layer 6 is arranged in such a manner so as to cover a total width of the belt layer 5, and is structured such as to suppress a lift of the belt layer 5 due to a centrifugal force at a time of traveling at a high speed, thereby enhancing a high-speed durability. As the reinforcing cord 6C, an organic fiber cord such as a polyester, a rayon, a nylon, an aramid or the like is preferably used.

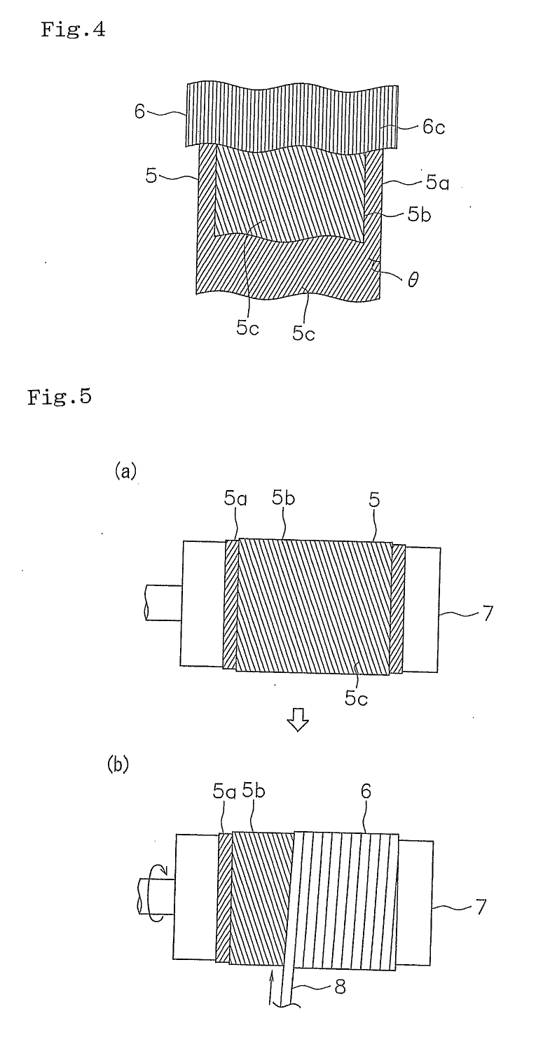

The belt layer 5 is formed by laminating a plurality of cylindrical belt plies 5a and 5b on a forming drum 7, as shown in FIG. 5, and the belt reinforcing layer 6 is formed by spirally winding the reinforcing cord 6C on an outer periphery of the belt layer 5. In the present embodiment, there is shown an example in which a band-like body 8 including a plurality of reinforcing cords 6C arranged in a line in a width direction is wound, however, one reinforcing cord 6C coated with a rubber may be used in place of the band-like body 8 as mentioned above. A width of the band-like body 8 is, for example, between 8 and 16 mm.

In FIG. 5(b), the band-like body 8 is supplied from a spiral supply apparatus (not shown), and the winding of the band-like body 8 can be executed by moving the spiral supply apparatus (that is, the band-like body 8) in an axial direction of the forming drum 7, while rotating the forming drum 7 in a predetermined direction. The spiral supply apparatus arranges the reinforcing cords 6C fed from a plurality of bobbins in a line, and applying a rubber coat thereto so as to extrude the band-like body 8. It may be possible to supply the band-like body 8 to the forming drum 7 by previously preparing a scroll obtained by winding the formed band-like body 8 and unwinding the scroll.

In this step of forming the belt reinforcing layer 6, the winding direction of the reinforcing cord 6C is set to an inverse direction to the direction of inclination of the belt cord 5C of the belt ply 5b positioned in the outermost periphery. In other words, in the example shown in FIG. 5, since the direction of inclination of the belt cord 5C is “leftward rise”, it is spirally wound in such a manner that the winding direction of the reinforcing cord 6C comes to “rightward rise”. In the case where the direction of inclination of the belt cord 5C is “rightward rise”, it may be wound in such a manner that the winding direction of the reinforcing cord 6C comes to “leftward rise”.

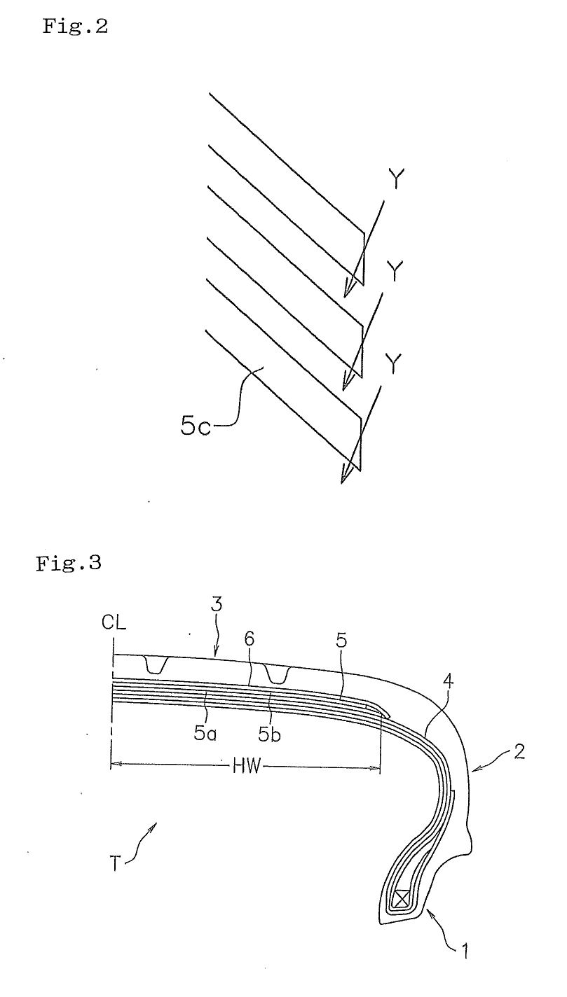

Therefore, the reinforcing cord 6C can be wound in a direction as shown in FIG. 2, with respect to the end portion of the belt cord 5C of the belt play 5b. Accordingly, the reinforcing cord 6C is hard to catch on the end portion of the belt cord 5C included in the belt ply 5b, or it is easy to set up against the pressure from the reinforcing cord 6C even if it catches, whereby it is possible to inhibit the belt layer 5 from being moved inside. Even if the reinforcing cord 6C catches on the end portion of the belt cord 5C of the belt ply 5a arranged in an inner peripheral side, the belt ply 5a bound by the belt ply 5b is hard to be moved inside.

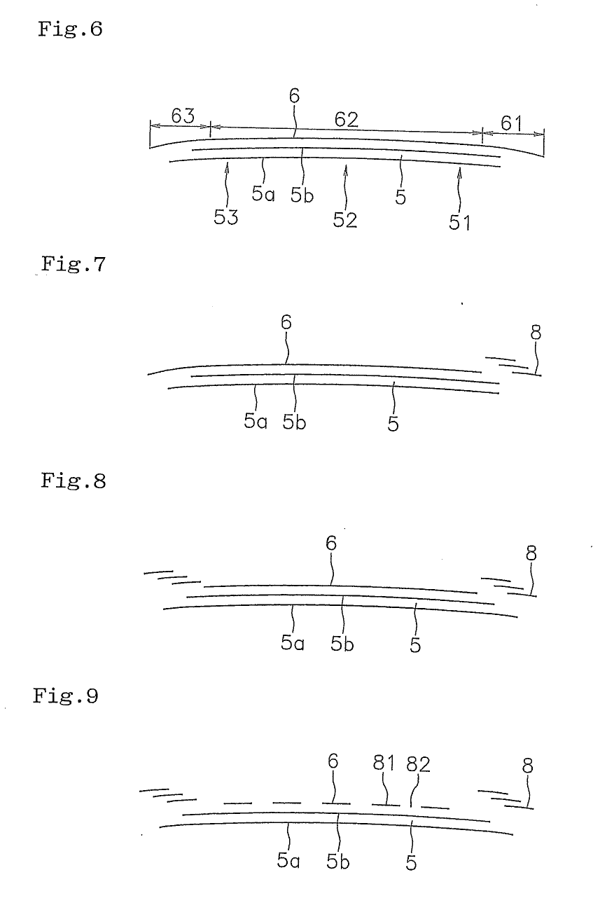

FIG. 6 is a diagrammatic view showing the belt layer 5 and the belt reinforcing layer 6, and draws the belt reinforcing layer 6 in which the adjacent band-like bodies 8 come into contact with each other in their edges by one line. The band-like body 8 is spirally wound from one end 51 of the belt layer 5 toward the other end 53 via a center region 52, and the belt reinforcing layer 6 has a start end portion 61 covering the one end 51, an intermediate portion 62 covering the center region 52, and a terminal end portion 63 covering the other end 53. The start end portion 61 and the terminal end portion 63 are portions respectively covering end portions of the belt plies 5a and 5b, and have a width which is about 30% of a belt half width HW.

In a modified example shown in FIG. 7, a cord tension and a winding pitch of the band-like body 8 are made smaller in the start end portion 61 than in the intermediate portion 62. Therefore, it is possible to weaken the pressure of the reinforcing cord 6C with respect to the end portion of the belt cord 5C arranged in one end 51 of the belt layer 5. Further, it is possible to compensate for a reduction of a binding force caused by making the cord tension smaller, by making a winding pitch of the band-like body 8 smaller in the start end portion 61, whereby it is possible to well secure the high-speed durability generated by the belt reinforcing layer 6.

The cord tension of the band-like body 8 can be changed by regulating a rotating speed of the forming drum 7 and a feed speed of the band-like body 8. Accordingly, in order to make the cord tension smaller in the start end portion 61, it is preferable to slow the rotation of the forming drum 7 or quicken the supply of the band-like body 8, at a time of winding the band-like body 8 so as to form the start end portion 61, in comparison with a time of forming the intermediate portion 62.

In this case, it is preferable that the cord tension (a spiral drawing tension per 8 mm width) in the start end portion 61 is below 1.0 kgf, and the cord tension in the intermediate portion 62 and the terminal end portion 63 is between 1.0 and 1.5 kgf.

The winding pitch of the band-like body 8 can be changed by regulating a moving speed of the spiral feed apparatus and the rotating speed of the forming drum 7. Accordingly, in order to make the winding pitch smaller in the start end portion 61, it is preferable to slow the moving speed of the spiral feed apparatus or quicken the rotation of the forming drum 7, at a time of winding the band-like body 8 so as to form the start end portion 61, in comparison with a time of forming the intermediate portion 62. In the present embodiment, in the start end portion 61, the adjacent band-like bodies 8 are overlapped with each other so as to be wound.

In a modified example shown in FIG. 8, the cord tension and the winding pitch of the band-like body 8 are made smaller even in the terminal end portion 63 in addition to the start end portion 61, than in the intermediate portion 62. Details of the cord tension and the winding pitch in the terminal end portion 63 can be set to the same as those of the start end portion 61 mentioned above. Thus, it is possible to effectively prevent the deterioration of the LFV by setting the terminal end portion 63 of the belt reinforcing layer 6 to the same structure as the start end portion 61.

In a modified example shown in FIG. 9, an arrangement portion 81 in which the band-like body 8 is arrange, and a defect portion 82 in which the band-like body 8 is not arranged are alternately arranged in the intermediate portion 62. The defect portion 82 can be formed by enlarging the winding pitch in such a manner that the adjacent band-like bodies 8 are positioned so as to be spaced from each other. Since the belt layer 5 is not covered with the belt reinforcing layer 6 in the defect portion 82, it is possible to enhance a degree of influence that a cord component of the belt ply 5b applies to a steering wheel flow. Since a constraint of both the ends 51 and 53 of the belt layer 5 becomes important for securing the high-speed durability, a reduction of the binding force with respect to the center region 52 by the defect portion 82 does not become problems so much.

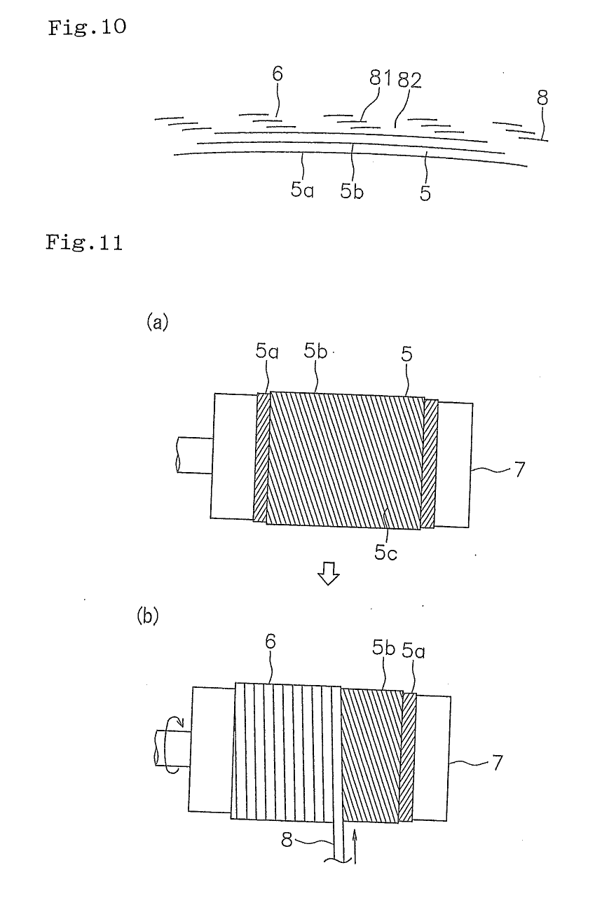

In a modified example shown in FIG. 10, the adjacent band-like bodies 8 are overlapped with each other in the arrangement portion 81 of the intermediate portion 62. In accordance with the method mentioned above, it is possible to enhance a binding force with respect to the belt layer 5, in the intermediate portion 62 of the belt reinforcing layer 6. The constraint of both the ends 51 and 53 of the belt layer 5 is important with regard to the high-speed durability as mentioned above, and the binding force in the intermediate portion 62 may be weakened in comparison with the start end portion 61 and the terminal end portion 63, by reducing the winding number of the band-like body 8 forming the arrangement portion 81, while taking a productivity into consideration.

### Examples

In order to specifically show the structure and the effect of the present invention, a description will be given of a result obtained by carrying out an evaluation of the following matters (1) to (3).

(1) Uniformity

Based on a test method defined in JISD4233, LFV (lateral force variation) was measured, and uniformity of a tire was evaluated. Specifically, there was measured an amount of fluctuation of a force in a tire lateral direction which is generated at a time of pressing the tire against the rotating drum and rotating the tire while holding a distance between both the shafts constant, and there was searched a defective rate at a time when a defect is set to a case where the amount of fluctuation goes beyond 98 N (10.0 kgf).

(2) Forming Time

A time required for forming the belt reinforcing layer was measured. A result of a comparative example 1 is set to 100 so as to be evaluated by an index number, and the greater numerical value indicates the longer forming time.

(3) High-Speed Durability

The tire was pressed against the drum having a diameter of 1.7 m so as to be rotated, a traveling speed is increased by 10 km/h per 10 minutes until the tire breaks down, and kilometer per hour at a time of breaking down was measured. A result of a comparative example 1 is set to 100 so as to be evaluated by an index number, and the greater numerical value indicates the more excellent the high-speed durability is.

The structure in which the belt reinforcing layer is formed in accordance with the procedure shown in FIG. 11 is set to the comparative example 1, and the structure in which the belt reinforcing layer is formed in accordance with the procedure shown in FIG. 5 is set to examples 1 to 4. The structures of the belt reinforcing layer in the examples 1 to 4 are respectively as shown in FIGS. 6, 7, 9 and 10. In any event, a tire size is set to 215/45R17, and a width of the band-like body is set to 8 mm. Further, an overlap margin of the band-like body in the examples 2 to 4 was set to 4 mm, and a width of the defect portion in the examples 3 and 4 was set to 8 mm. Results of the evaluation are shown in Table 1.

TABLE 1

| | | | High-speed |
|---|---|---|---|
| | LFV(%) | Forming time | durability |
| Comparative | 2.20 | 100 | 100 |
| Example 1 | | | |
| Example 1 | 0.50 | 100 | 100 |
| Example 2 | 0.40 | 105 | 102 |
| Example 3 | 0.40 | 90 | 103 |
| Example 4 | 0.40 | 100 | 103 |

As shown in Table 1, in the examples 1 to 4, the LFV is improved in comparison with the comparative example 1, and it can be thought that the generation of the displacement caused by the lift of the belt layer was suppressed. Further, in the examples 2 to 4, the LFV is further improved, and there can be seen an effect obtained by making the cord tension of the band-like body smaller in the start end portion. In addition, in the examples 2 to 4, it is possible to well secure the high-speed durability by making the winding pitch of the band-like body smaller in the start end portion.

What is claimed is:

1. A method of manufacturing a pneumatic tire which is provided with a belt reinforcing layer obtained by spirally winding a reinforcing cord, in a tread side of a belt layer arranged in a tread portion, the method comprising:
a step of laminating a plurality of cylindrical belt plies including a belt cord extending while inclining with respect to a tire circumferential direction so as to form the belt layer; and
a step of spirally winding the reinforcing cord on an outer periphery of the belt layer so as to form the belt reinforcing layer,
wherein a winding direction of the reinforcing cord is set to an inverse direction to a direction of inclination of the belt cord of the belt ply positioned in an outermost periphery.

2. The method of manufacturing a pneumatic tire according to claim 1, wherein the step of forming the belt reinforcing layer is structured such as to spirally wind a band-like body including a plurality of the reinforcing cords arranged in a line from one end of the belt layer toward the other end via a center region, and makes a cord tension and a winding pitch of the band-like body smaller in a start end portion covering the one end of the belt layer, than in an intermediate portion covering the center region of the belt layer.

3. The method of manufacturing a pneumatic tire according to claim 2, wherein the step of forming the belt reinforcing layer makes the cord tension and the winding pitch of the band-like body smaller in a terminal end portion covering the other end of the belt layer, than in the intermediate portion covering the center region of the belt layer.

4. The method of manufacturing a pneumatic tire according to claim 2, wherein the step of forming the belt reinforcing layer alternately arranges an arrangement portion in which the band-like body is arranged, and a defect portion in which the band-like body is not arranged, in the intermediate portion covering the center region of the belt layer.

5. The method of manufacturing a pneumatic tire according to claim 4, wherein the adjacent band-like bodies overlap with each other in the arrangement portion.

6. A pneumatic tire which is provided with a belt reinforcing layer obtained by spirally winding a reinforcing cord, in a tread side of a belt layer arranged in a tread portion,
wherein the belt layer is formed by laminating a plurality of cylindrical belt plies including a belt cord extending while inclining with respect to a tire circumferential direction, and the belt reinforcing layer sets a winding direction of the reinforcing cord to an inverse direction to a direction of inclination of the belt cord of the belt ply positioned in an outermost periphery.
